(19) United States
(12) Patent Application Publication
(10) Pub. No.: US 2005/0095504 A1
(43) Pub. Date: May 5, 2005

(54) Negative electrode for lithium metal battery and lithium metal battery comprising the same

(76) Inventors: Hee-Tak Kim, Suwon-si (KR); Su-Suk Choi, Suwon-si (KR); Yun-Suk Choi, Suwon-si (KR); Sang-Eun Cheon, Suwon-si (KR); Ji-Seong Han, Suwon-si (KR)

Correspondence Address: CHRISTIE, PARKER & HALE, LLP, PO BOX 7068, PASADENA, CA, 91109-7068, US

(21) Appl. No.: 10/962,636

(22) Filed: Oct. 11, 2004

(30) Foreign Application Priority Data
Oct. 31, 2003 (KR) 2003-0076907

(51) Int. Cl. H01M 2/16; B05D 3/02

(52) U.S. Cl. 429/246; 429/254; 427/388.2

(57) ABSTRACT

The present invention relates to a negative electrode for a lithium metal battery and a lithium metal battery comprising the same. The negative electrode of the present invention comprises a negative active material layer of metallic lithium or a lithium alloy, and a passivation layer formed on the negative active material layer. The passivation layer has a structure comprising a 3-dimensionally cross-linked polymer network matrix penetrated by linear polymers. The passivation layer formed on the surface of the negative electrode reduces reactivity of the negative electrode and stabilizes the surface, so that it offers a lithium metal battery having superior life cycle characteristics.

### CROSS REFERENCE TO RELATED APPLICATION

This application claims the benefit of and priority to Korean Patent Application No.10-2003-0076907 filed in the Korean Intellectual Property Office on Oct. 31, 2003, the entire disclosure of which is incorporated herein by reference.

### BACKGROUND OF THE INVENTION

(a) Field of the Invention

The present invention relates to a negative electrode for a lithium metal battery and a lithium metal battery comprising the same, and more particularly to a negative electrode for a lithium metal battery having superior life cycle characteristics and a lithium metal battery comprising the same.

(b) Description of the Related Art

With the rapid development of electricity, electronics, communications, and computer industries, demand for high performance and highly stable secondary batteries is increasing rapidly. In particular, with the trend toward compact, light, and portable electrical and electronics products, demand for light and compact secondary batteries is increasing. Also, as environmental pollution such as air and noise pollution becomes severe as the number of cars increases, and new types of energy are required as petroleum is being exhausted, demand on the development of electric vehicles has increased. For power sources for these electric vehicles, development of fuels having both high power output and high energy density is required.

In this regard, one of the most spotlighted high performance cutting-edge batteries is the lithium metal battery (LMB). The lithium metal battery is a battery using metallic lithium as a negative electrode. Such batteries can be classified as either lithium ion or lithium sulfur batteries. Because lithium has a low density of 0.54 g/cm³ and a very low standard reduction potential of −3.045 V SHE (standard hydrogen electrode), it is promising as a high energy density electrode material. However, certain problems have tended to prevent its use as a negative electrode.

First, when lithium is used as a negative electrode for an ion battery, it reacts with impurities such as electrolytes, water, and organic solvents or lithium salts to form a solid electrolyte interphase (SEI) layer. The SEI layer causes a local current density gradient and thus facilitates dendrite formation during charging. The dendrites grow gradually during charging and discharging, and can cause short circuits of the positive electrode and the negative electrode. Also, since the dendrites have a mechanically weak part (bottle neck), they tend to form “dead lithium” which loses electrical contact with the current collector during discharging, reducing the battery's capacity and life cycle, and negatively affecting battery stability. The above-mentioned non-uniform oxidation-reduction and reactivity with the electrolyte solution generally prevents the use of lithium as a negative electrode for a lithium ion battery.

When lithium is used as a negative electrode of a lithium sulfur battery, lithium polysulfide generated during charging and discharging reacts with the lithium negative electrode by the shuttle mechanism. Therefore, it is impossible to obtain high charge efficiency and the discharge capacity of the lithium sulfur battery is limited. Lithium polysulfide is generated by electrochemical reduction of sulfur, the active material of the positive electrode of the sulfur battery, in the range of 2.4 V during discharging. Or, lithium disulfide and lithium sulfide are generated on the carbon matrix inside the positive electrode in the range of 2 V as reduced solids, and these materials are oxidized to lithium polysulfide.

Reaction of lithium polysulfide and metallic lithium can take place in the lithium negative electrode as lithium polysulfide is dissolved in the electrolyte solution. When the passivation layer formed on the lithium negative electrode surface is damaged during charging and discharging, highly active lithium (bare Li) becomes exposed. Such reaction of lithium polysulfide and metallic lithium reduces charging efficiency and causes spontaneous discharge of the battery.

In order to solve the problems of the reaction of metallic lithium with the electrolyte solution and the dendrite formation, U.S. Pat. No. 4,002,492 suggests the use of a lithium-aluminum alloy as the negative electrode. However, low capacity, weak mechanical properties (brittleness), low discharge potential, and low specific capacity of the negative electrode are its disadvantages. U.S. Pat. No. 6,537,702 discloses an lithium-aluminum alloy passivation layer that contains Al₂S₃ that is formed on a metallic lithium surface for a lithium sulfur battery.

U.S. Pat. No. 4,503,088 proposes use of an epoxy resin solution coated on a lithium negative electrode as a passivation layer. However, direct contact of the solvent with metallic lithium may cause generation of reaction byproducts and bubbling at the interface. U.S. Pat. No. 4,359,818 proposes pressing a passivation layer made into a thin film on metallic lithium. However, because of the difficulty in making and handling the thin film, the passivation layer should have a high ion conductivity.

U.S. Pat. No. 4,934,306 discloses that a passivation layer solution may be coated on a porous film, dried, and pressed onto metallic lithium. However, the use of a porous film makes it difficult to block the contact of the electrolyte solution with the metallic lithium.

U.S. Pat. Nos. 5,342,710 and 5,487,959 disclose that metallic lithium may be protected by using a complex of I₂ and poly-2-vinylpyridine as a passivation layer, so that I₂ reacts with the metallic lithium to form Lil. However, such an approach can cause a decrease in ion conductivity and interface instability.

U.S. Pat. No. 5,961,672 discloses a vacuum-deposited conductive film as a passivation layer for a lithium negative electrode. However, processing in a high vacuum is complicated and costly. Moreover, monomers available for vacuum deposition are limited and the deposition rate is low.

U.S. Pat. Nos. 6,214,061 and 6,432,584 disclose the preparation of a passivation layer for a lithium negative electrode by depositing an inorganic single-ion conductor on the lithium negative electrode surface. However, the resultant passivation layer may crack during repeated reaction on the lithium surface due to its weak mechanical strength. Furthermore, the deposition rate is low. U.S. Pat. No. 5,314,765 discloses the preparation of a passivation layer for a lithium negative electrode by depositing multi-layered inorganic single-ion conductors on the lithium negative electrode surface. However, the resultant passivation layer has weak mechanical strength and the deposition rate is low.

Stabilization techniques for a lithium negative electrode of a lithium thionyl chloride battery and a lithium primary battery have been reported. U.S. Pat. Nos. 4,503,088 and 4,359,818 disclose the preparation of a passivation layer by coating alkyl acrylate, alkyl-substituted acrylate, or alkyl cyanoacrylate based polymer on lithium.

Korea Patent Publication No. 2003-42288 discloses the preparation of a passivation layer by coating a lithium negative electrode with a solution comprising an electrolyte solution component, cross-linking monomers, and an initiator, and applying UV light or heat. The result was reduced reaction of the electrolyte solution with lithium. However, because the liquid passivation layer component is coated on lithium, cross-linking of the passivation layer component should be performed just after metallic lithium has been coated to obtain a uniform passivation layer. Therefore, the quality of the passivation layer is determined by the cross-linking time. As the cross-linking of the passivation layer proceeds, the passivation layer film becomes hard and brittle, and thus the passivation layer may be broken during charging and discharging due to the volume change at the lithium surface. The passivation layer becomes soft if the cross-linking of the passivation layer is reduced. However, when contacted with the electrolyte solution, the passivation layer may be swollen, and if the swelling is severe, lithium peels off the passivation layer. Also, because the passivation layer contains an excess of the electrolyte solution component, the electrolyte solution reacts with lithium continuously.

### SUMMARY OF THE INVENTION

In one embodiment of the present invention, a negative electrode for a lithium metal battery is provided that is capable of improving life cycle characteristics by preventing side reactions of the negative electrode with the electrolyte solution.

In another embodiment of the present invention, a lithium metal battery is provided comprising the negative electrode.

In an embodiment of the present invention, a negative electrode for a lithium metal battery is provided comprising a negative active material layer of metallic lithium or a lithium alloy, and a passivation layer formed on the negative active material layer in which the passivation layer has a structure of a 3-dimensionally cross-linked polymer network matrix penetrated by linear polymers.

In yet another embodiment of the present invention, a lithium metal battery is provided comprising the negative electrode, a positive electrode comprising a positive electrode active material, and an electrolyte solution.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 is a schematic diagram of the polymer network of the passivation layer according to an embodiment of the present invention.

FIG. 2 is a schematic diagram of the polymer network of the passivation layer according to another embodiment of the present invention.

FIG. 3 is a schematic diagram showing the structure of a lithium metal battery.

FIG. 4 is a schematic diagram of a negative electrode of the present invention.

FIG. 5 is a schematic diagram showing the adhesion state of a passivation layer of a negative electrode of the present invention and the separator.

FIG. 6 is the voltage curve during charging and discharging of the lithium half cell of Comparative Example 1.

FIG. 7 is the voltage curve during charging and discharging of the lithium half cell of Example 1.

FIG. 8 is the voltage curve during charging and discharging of the lithium half cell of Example 2.

FIG. 9 is the charging-discharging graph of the lithium half cells of Example 7 and Comparative Example 5 for initial cycles.

FIG. 10 is the capacity graph comparing discharging capacities of Example 7 and Comparative Example 5.

### DETAILED DESCRIPTION

Embodiments of the present invention will now be described in detail with reference to the accompanying drawings.

The present invention relates to a negative electrode for a lithium metal battery having an organic passivation layer formed on the negative electrode, and which is thus capable of improving a battery's life cycle characteristics by preventing reaction of the lithium negative electrode with the electrolyte solution. The term “lithium metal battery” refers to a battery using metallic lithium as the negative electrode. Such batteries are generally classified as lithium ion batteries or lithium sulfur batteries. It is also recognized that a battery using a lithium alloy instead of metallic lithium is included in the definition of lithium metal batteries.

Because metallic lithium has a standard reduction potential of −3.04 V, the lowest reduction potential of all solid negative active materials, it can offer the highest cell potential when used as a negative electrode. Also, metallic lithium has a capacity per unit weight of 3860 mAh/g, which is the largest of all known negative active materials. Accordingly, metallic lithium is a suitable material for lightweight and high-capacity batteries.

However, when metallic lithium is used in an ion battery, needle-shaped lithium protrusions called dendrites tend to form on the lithium negative electrode surface. If the dendrites grow excessively and contact the positive electrode, internal short circuits may occur. While metallic lithium is oxidized to lithium ions during discharging and then reduced again to lithium during charging, the volume change at the metallic lithium surface causes deposition of lithium to happen locally, not uniformly. Also, because metallic lithium is highly reactive with the electrolyte solution component, a spontaneous reaction occurs when the electrolyte solution component contacts the metallic lithium, forming a film referred to as a passivation layer. Because the passivation layer is formed and destroyed repeatedly during charging and discharging, the electrolyte solution becomes depleted and the passivation layer component increases in the lithium negative electrode as the battery is repeatedly charged and discharged. Furthermore, reaction of the electrolyte solution with the dendrites may cause electrical short circuits of the dendrites with metallic lithium. When this occurs, such lithium is referred to as “dead lithium”, as is no longer able to participate in the electrochemical reactions.

In general, the properties of the metallic lithium passivation layer largely depend on the kind of the electrolyte solution used. If the passivation layer is porous, the passivation layer becomes several microns thick due to incessant reaction of the electrolyte solution and lithium. Otherwise, if the passivation layer is dense, contact of the electrolyte solution and lithium is blocked so that continuous growth of the passivation layer is prevented. Accordingly, it is necessary to prevent dendrite formation on the lithium and minimize reaction of the electrolyte solution with lithium in order to prevent depletion of the electrolyte solution and formation of dead lithium.

In this regard, one of the properties required of the passivation layer of the lithium negative electrode is enough mechanical strength to prevent dendrite growth. That is, the passivation layer should have enough mechanical strength to prevent growth of dendrites in the vertical direction of the passivation layer film by locally concentrated lithium deposition. Because a passivation layer comprising inorganic material tends to have low toughness, it may be broken by a volume change at the metallic lithium surface due to lithium deposition. Therefore, it is preferable that the passivation layer comprises a polymer having high toughness. Also, the passivation layer should have good adhesivity to metallic lithium. If the adhesivity is low, metallic lithium may peel from the passivation layer. Also, the passivation layer should be able to effectively block the electrolyte solution. For this purpose, the passivation layer should also be resistant to swelling when exposed to the electrolyte solution.

The negative electrode for a lithium metal battery of the present invention comprises a first layer of a negative active material comprising metallic lithium or lithium alloy, and a passivation layer formed on the first layer. The lithium alloy may comprise metals selected from the group consisting of Al, Mg, K, Na, Ca, Sr, Ba, Si, Ge, Sb, Pb, In, and Zn. The negative active material layer may be a lithium foil, a lithium alloy foil, lithium deposited on a polymer film with a metal current collector, or metallic lithium alloy deposited on a polymer film with a metal current collector, but is not limited to such embodiments.

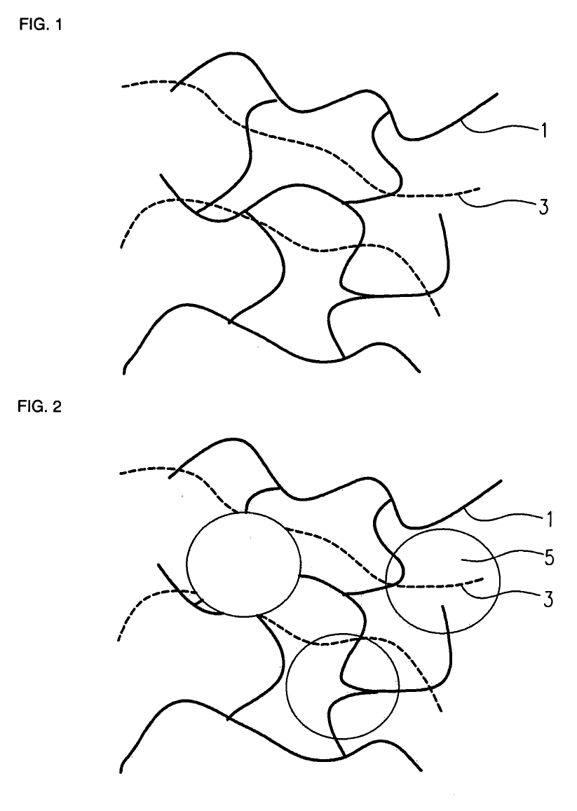

The passivation layer of the present invention has a 3-dimensionally cross-linked polymer network matrix penetrated by linear polymers. The passivation layer has an interpenetrating polymer network (IPN) structure, as depicted in FIG. 1. In general, a cross-linked polymer network is not dissolved in a solvent, and shows different swelling degrees depending on the spacing of cross-linking points and chemical structure of the chains. Given the same chemical structure, the swelling degree decreases as the spacing of cross-linking points decreases, or as the cross-linking density increases. Accordingly, the amount of electrolyte solution in the passivation layer decreases as the spacing of cross-linking points decreases, and thus, the reaction of the lithium negative electrode with the electrolyte solution is reduced. However, as the cross-linking density increases, the film becomes harder and loses flexibility, so that it may be broken, or lithium metal may be peeled off the lithium negative electrode. As illustrated by FIG. 1, when linear polymers 3 having good mechanical strength are introduced into the cross-linking polymer network 1, the mechanical strength of the adhesivity of the passivation layer may be improved without altering the cross-linking density. The cross-linking density may be defined by the weight-average molecular weight (Mx) of the polymer chain between each cross-linking point. Preferably, the polymer chain has a weight-average molecular weight ranging from 50 to 20,000, more preferably from 200 to 10,000.

Cross-linking of the polymer is performed by applying heat or UV light to the cross-linking monomers. Preferably, the cross-linked polymer network has a weight-average molecular weight of the polymer chain between each cross-linking point ranging from 50 to 100,000. Examples of cross-linking monomers are polyethylene oxide diacrylate, polyethylene oxide dimethacrylate, polypropylene oxide diacrylate, polypropylene oxide dimethacrylate, polymethylene oxide diacrylate, polymethylene oxide dimethacrylate, alkyldiol diacrylate, alkyldiol dimethacrylate, divinylbenzene, and mixtures thereof. As the length of the polymer chain between each cross-linking point decreases, the swelling degree decreases, and thus the reaction between lithium and the electrolyte solution may be prevented more effectively. However, ion conductivity of the passivation layer decreases as the length of the polymer chain between each cross-linking point decreases.

Preferably, the linear polymer has a weight-average molecular weight ranging from 50,000 to 10,000,000. Examples of linear polymers include polyether, polycarbonate, polyamide, polyester, polyvinyl chloride, polyvinylidene fluoride, polyimide, polycarboxylate, polysulfonate, polyvinyl alcohol, polysulfone, polystyrene, polyethylene, and polypropylene-based polymers, or copolymers thereof or blends thereof, but is not limited by them. The linear polymer is uniformly miscible with monomers that form a cross-linking network, and has superior mechanical strength and good adhesivity with metallic lithium. Also, it is chemically stable and does not participate in side reactions with lithium.

Because the cross-linked polymer and the linear polymer do not chemically bond, the presence of the linear polymer can be confirmed by immersing the passivation layer of the present invention in an organic solvent to dissolve the linear polymer and permit the extraction of the linear polymer.

The cross-linked polymer and the linear polymer are provided in a weight ratio of 50/1 to 1/5, preferably 10/1 to 1/1, and more preferably 5/1 to 3/1, by weight.

The passivation layer of the present invention may further comprise inorganic particles in the polymer network. FIG. 2 shows a polymer network comprising inorganic particles 5. The inorganic particles improve toughness of the passivation layer. The inorganic particles may or may not have lithium ion conductivity. If the inorganic particles have lithium ion conductivity, they reduce resistance of the passivation layer. In one embodiment, the inorganic particles should have higher lithium ion conductivity than the polymer network passivation layer to lower resistance of the passivation layer.

The inorganic particles generally have a diameter ranging from 1 nm to 10 microns, and preferably from 0.1 micron to 1 micron. Examples of inorganic particles not having lithium ion conductivity are SiO₂, Al₂O₃, TiO₂, BaTiO₂, Ba₂O₃ and mixtures thereof. Examples of inorganic particles having lithium ion conductivity are lithium oxysulfide, lithium nitride, lithium phosphorus oxynitride, lithium silicon disulfide, lithium boron disulfide, and mixtures thereof.

A lithium ion conductivity coating film may be formed between the negative active material layer and the passivation layer. Preferably, the lithium ion conductivity coating film is an inorganic coating film, an organic coating film, or a composite coating film. The inorganic coating film is made of materials selected from the group consisting of Cu, Al, Co, Fe, Ag, Zn, Mg, B, Sn, Pb, Cd, Si, In, Ga, lithium oxysulfide, lithium nitride, lithium phosphorus oxynitride, lithium silicon sulfide, lithium silicon disulfide, lithium boron sulfide, lithium boron disulfide, lithium silicate, lithium borate, lithium phosphate, lithium phosphoronitride, lithium aluminosulfide, and lithium phosphosulfide. The organic passivation layer is made of a conductive monomer, oligomer, or polymer selected from the group consisting of poly(p-phenylene), polyacetylene, poly(p-phenylene vinylene), polyaniline, polypyrrole, polythiophene, poly(2,5-ethylene vinylene), acetylene, poly(perinaphthalene), polyacene, and poly(naphthalene-2,6-diyl). Preferably, the lithium ion conductivity coating film has a thickness of 1 micron or less. A lithium ion conductivity coating film is desired in order to minimize reaction of the coating solvent with lithium during the coating of the passivation layer.

Hereinafter, a method for preparing the passivation layer is described.

The passivation layer is formed by applying a passivation layer coating composition on the negative electrode. First, cross-linking monomers, a linear polymer, and a cross-linking initiator are mixed in a dehydrated non-aqueous solvent and stirred to obtain a uniform coating composition. The cross-linking monomers and the linear polymer are the same as mentioned in the description of the passivation layer. For the cross-linking initiator, a substance that can form radicals at a given temperature is used. Examples of cross-linking initiators are peroxides such as benzoyl peroxide, lauryl peroxide, acetyl peroxide, dilauryl peroxide, di-tert-butyl peroxide, and cumyl hydroperoxide, and azo (—N═N—) compounds such as azobisisobutyronitrile and azobisisovaleronitrile. The cross-linking initiator is used at 0.1 to 3 wt %, and preferably at 0.5 to 2 wt %, for the cross-linked polymer network.

The passivation layer coating composition of the present invention may further comprise a cross-linking agent such as phenylene maleimide.

For the coating solvent, tetrahydrofuran, acetonitrile, chloroform, acetone, dioxolane, dimethyl ether, ethyl methyl ether, monochloroethane, dichloroethane, trichloroethane, dimethoxyethane, triglyme, or tetraglyme may be used. The passivation layer component takes up 1 to 30 wt % of the coating composition.

The coating composition may further comprise a lithium salt used in the electrolyte solution of a lithium battery. That is, a lithium salts such as LiClO₄, LiBF₄, LiPF₆, LiAsF₆, LiAsCl₆, LiCF₃SO₃, LiN(SO₂CF₃)₂, or LiN(SO₂CF₂CF₃)₂may be added. When a lithium salt is added, the overpotential becomes low at the beginning of discharging because lithium ions are present in the passivation layer.

The inorganic particles, which are added to reduce resistance of the passivation layer and enhance mechanical strength, may be added to the passivation layer coating composition.

After coating the negative electrode with the coating composition, the negative electrode is dried and the coating solvent is evaporated to prepare a passivation layer precursor film. Coating may be carried out by any means for forming a uniform film on the negative electrode. Examples include, doctor blade coating, dip coating, gravure coating, slit die coating, spin coating, reverse roll coating, screen coating, and cap coating.

In one embodiment, the negative electrode on which the passivation layer precursor film has been coated is heated to initiate radical polymerization of the cross-linking monomers in the passivation layer in order to form a cross-linked polymer network. Preferably, the heating temperature is 60 to 120° C. The cross-linking reaction is preferably performed under an inert gas atmosphere of nitrogen or argon. In another embodiment, the cross-linking reaction may be initiated by UV illumination of the negative electrode on which the passivation layer precursor film has been coated. Preferably, the UV cross-linking reaction is performed under an inert gas atmosphere of nitrogen or argon.

For a conventional passivation layer having a cross-linked polymer network, liquid cross-linking monomers are coated on the metallic lithium surface, and heat and UV light are applied to obtain a solid film. In the present invention, a coating composition comprising a mixture of linear polymer and cross-linking monomers is coated on the metallic lithium surface to form a passivation layer precursor film, and heat and UV light are applied to form a cross-linked polymer network matrix structure.

In the present invention, the film is formed before the cross-linking monomers react because of the film formation characteristics of the linear polymer. Therefore, it is not necessary to perform cross-linking immediately after film coating. Instead, the negative electrode can be transferred or stored as coated in the roll form, and the coated roll may be thermoset in an oven. This characteristic is advantageous in terms of processability. Conventional liquid cross-linking monomers cannot be coated on the negative electrode surface in the roll form, because the liquid flow would result in a non-uniform film thickness. Also, cross-linking of liquid monomers should be performed immediately after monomer coating. The present invention significantly improves processability in manufacturing a negative electrode passivation layer by introducing the linear polymer component.

According to the present invention, metallic lithium, which has previously been somewhat restricted in its use because of its high reactivity, can be used as a negative electrode upon formation of a passivation layer on its surface.

Also, for a metallic lithium sulfur battery, a negative electrode of metallic lithium is so reactive that lithium sulfide or lithium polysulfide generated during charging and discharging reacts with the electrolyte solution, leading to a rapid loss of lithium and gradual growth of lithium dendrites. As a result, the life span of the battery is reduced. However, the present invention prevents side reactions of metallic lithium, lithium sulfide, or lithium polysulfide with the electrolyte solution during charging and discharging, and prevents lithium dendrite formation by forming a passivation layer on the lithium negative electrode, thereby improving life cycle of the battery.

Hereinafter, a lithium metal battery comprising the negative electrode of the present invention is described. The positive electrode comprises a positive active material which can participate in electrochemically reversible oxidation/reduction reactions. The positive active material may be an intercalation compound capable of reversible intercalation/deintercalation (e.g., lithium transition metal oxide), which is commonly used in a lithium ion battery, or an inorganic sulfur (S₈) or sulfur based compound, which is commonly used in a lithium sulfur battery. The sulfur-based compound may be selected from the group consisting of sulfides [Li₂Sₙ (n≧1)], organic sulfur compounds, and carbon-sulfur polymers [(C₂Sₓ)ₙ: x=2.5 to 50, n≧2]. The sulfides may include 2,5-dimercapto-1,3,4-thiadiazole, and 1,3,5-trithiocyanuic acid. Also, a catholyte, which is prepared by preparing a positive electrode not containing sulfur or organic sulfur and adding a sulfur-containing active material to the electrolyte solution, may be used as the positive electrode.

The lithium metal battery of the present invention may further comprise an electrolyte solution and a separator, if required. The electrolyte solution and the separator may be of the type used in conventional lithium metal batteries. For a metallic lithium sulfur battery, the electrolyte solution may contain a non-aqueous organic solvent and a lithium salt. The non-aqueous organic solvent may be a single organic solvent or a mixture of two or more organic solvents. If a mixture of two or more organic solvents is used, it is preferable to select the solvents from at least two of the three groups consisting of weakly polar solvents, strongly polar solvents, and lithium protecting solvents.

Weakly polar solvents include aryl compounds, bicyclic ethers, and acyclic carbonates having a dielectric constant smaller than 15 and thus are capable of dissolving sulfur. Strongly polar solvents include acyclic carbonates, sulfoxides, lactones, ketones, esters, sulfates, and sulfites having a dielectric constant larger than 15 and thus are capable of dissolving lithium polysulfide. Lithium protecting solvents include saturated ether compounds, unsaturated ethers, and hetero ring compounds having N, O, or S, which have charging-discharging cycle efficiency of 50% or more and are capable of forming an SEI (solid electrolyte interface) film that stabilizes metallic lithium.

Specific examples of weakly polar solvents are xylene, dimethoxyethane, 2-methyltetrahydrofuran, diethyl carbonate, dimethyl carbonate, toluene, dimethyl ether, diethyl ether, diglyme, and tetraglyme.

Specific examples of strongly polar solvents are hexamethyl phosphoric triamide, y-butyrolactone, acetonitrile, ethylene carbonate, propylene carbonate, N-methylpyrrolidone, 3-methyl-2-oxazolidone, dimethylformamide, sulfolane, dimethyl acetamide, dimethyl sulfoxide, dimethyl sulfate, ethylene glycol diacetate, dimethyl sulfite, and ethylene glycol sulfite.

Specific examples of lithium protecting solvents are tetrahydrofuran, ethylene oxide, dioxolane, 3,5-dimethylisoxazole, 2,5-dimethylfuran, furan, 2-methylfuran, 1,4-oxane, and 4-methyldioxolane.

Examples of lithium salts include lithium trifluoromethanesulfoneimide, lithium triflate, lithium perchlorate, LiPF₆, LiBF₄, tetraalkylammoniums such as tetrabutylammonium tetrafluoroborate, and imidazolium salts that are liquid at room temperature such as 1-ethyl-3-methylimidazolium bis-(perfluoroethylsulfonyl)imide. The salt concentration of the electrolyte solution is from 0.1 to 2.0 M.

The electrolyte solution may be either in liquid or polymer form.

The separator is introduced to prevent short circuits between the positive electrode and the negative electrode. A polymer film of polypropylene or polyethylene or a composite film thereof may be used as the separator.

The lithium secondary battery comprising the negative electrode, the positive electrode, the electrolyte solution, and the separator may have the positive electrode/separator/negative electrode structure of a unit cell, the positive electrode/separator/negative electrode/separator/positive electrode structure of a bicell, or the structure of repeating unit cells of a composite cell.

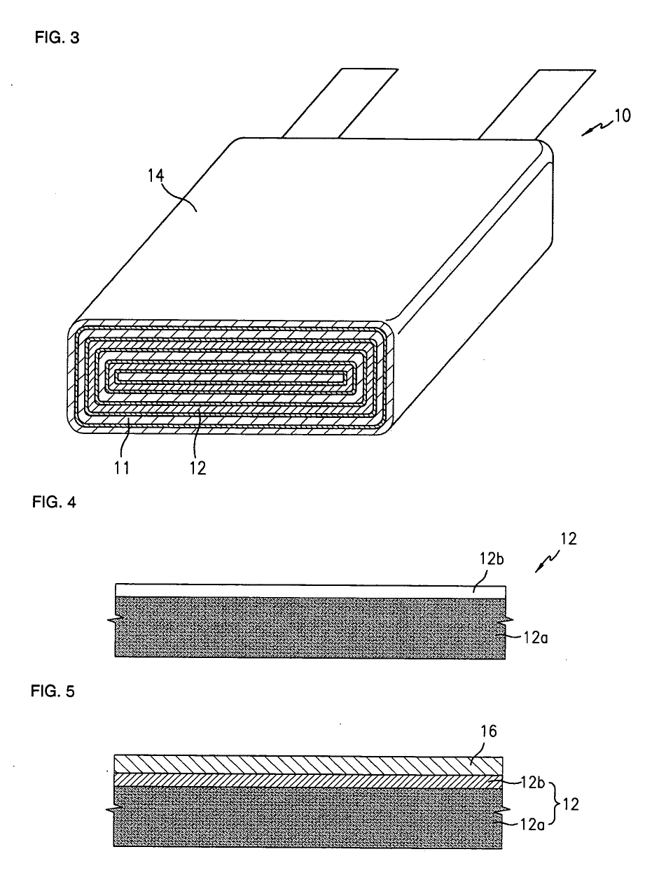

FIG. 3 illustrates a typical structure for a lithium metal battery of the present invention. As seen in FIG. 3, the lithium metal battery comprises a positive electrode 11, a negative electrode 12, and a battery can 14 enclosing them. FIG. 4 shows the negative electrode 12 of the present invention. As seen in FIG. 4, a passivation layer 12b is formed on a negative active material layer 12a.

Because the passivation layer formed on the negative electrode has good adhesivity, the negative electrode 12 and the separator 16 may be bound together, as seen in FIG. 5. For example, if cross-linking of the passivation layer precursor is performed under appropriate pressure and temperature after contacting the lithium negative electrode on which the passivation layer precursor has been coated with the separator, cross-linked networks are formed on each surface of the lithium negative electrode and the separator, so that the metallic lithium and the separator are bound together. Binding of the separator and the lithium electrode may also be attained by preparing a composite battery comprising the lithium negative electrode, a separator, and a positive electrode, on which the passivation layer precursor has been coated, and applying appropriate pressure and heat.

One of the reasons why lithium negative electrodes tend to have short life cycle is that the interface between the separator and the lithium negative electrode is non-uniform, and thus the reaction is concentrated locally. If the negative electrode and the separator are bound together as in the present invention, the interface between the separator and metallic lithium becomes uniform, so that local concentration of electrochemical reaction can be minimized.

Hereinafter, the present invention is described in more detail through Examples and Comparative Examples. However, the following examples are only for the understanding of the present invention and they do not limit the present invention.

### EXAMPLES

### Comparative Example 1

A lithium half cell was prepared using lithium deposited to a thickness of 15 microns on a copper current collector as a working electrode, and a lithium foil with a thickness of 100 microns as a counter electrode. A porous polyethylene separator with a thickness of 16 microns was placed between the working electrode and the counter electrode. A plastic pouch coated with aluminum was used, and dimethoxyethane/diglyme/dioxolane (volume ratio=4/4/2) in which 1M LiN(CF₃SO₂)₂ had been dissolved was injected as an electrolyte solution.

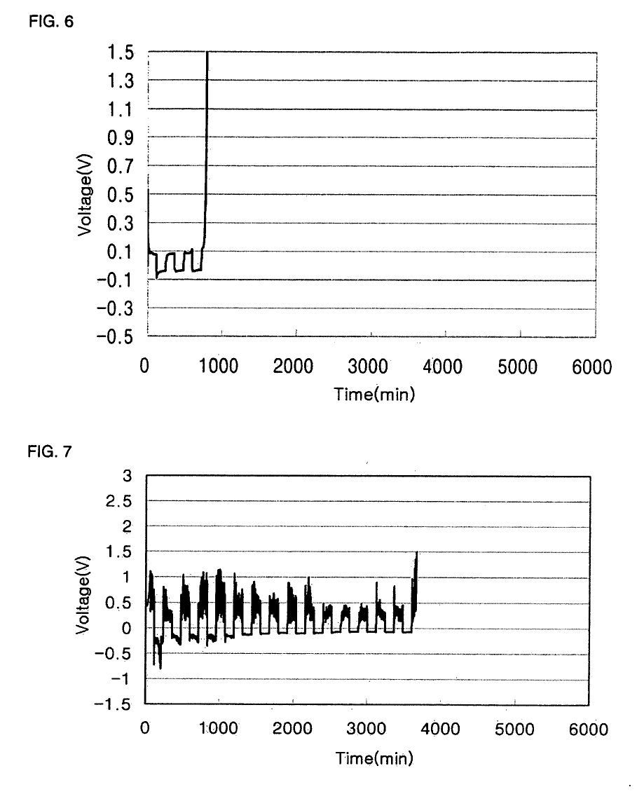

The resultant battery was charged and discharged for two hours with a current density of 1 mA/cm². FIG. 6 shows the cell voltage change during charging and discharging.

During discharging, lithium was deposited at the working electrode and stripped at the counter electrode. The cell voltage during discharging was −100 mV. During charging, lithium was stripped at the working electrode and deposited at the negative electrode. The cell voltage during charging was 100 mV. During the third charge, the cell voltage rose to 1.7 V. This means that lithium was depleted at the working electrode by the third cycle.

The coulombic efficiency of the electrolyte solution was 63.9%, and the FOM (figure of merit) was 2.77. During charging and discharging, metallic lithium is converted to dead lithium, which can no longer be used. The FOM is the average number of cycles required to completely deplete one lithium atom (i.e., the number of cycles required for a lithium atom to be converted to dead lithium).

### Comparative Example 2

A homogeneous solution was prepared by dissolving 0.2 g of polyvinyl chloride (Aldrich) having a weight-average molecular weight of 1,000,00 in 6.2 g of tetrahydrofuran. The solution was coated on lithium which had been deposited to a thickness of 15 microns on a copper current collector. The coating thickness was 1 micron. A lithium half cell was prepared using the lithium coated with the polyvinyl chloride as a working electrode, and a lithium foil with a thickness of 100 microns as the counter electrode. A porous polyethylene separator with a thickness of 16 microns was placed between the working electrode and the counter electrode. A plastic pouch coated with aluminum was used, and dimethoxyethane/diglyme/dioxolane (volume ratio=4/4/2) in which 1M LiN(CF₃SO₂)₂ had been dissolved was injected as an electrolyte solution.

The resultant battery was charged and discharged for two hours with a current density of 1 mA/cm². The coulombic efficiency of the electrolyte solution was 71.6%, and the FOM was 3.52.

### Comparative Example 3

A solution was prepared by dissolving 2 g of hexanediol diacrylate, 2 g of tetraglyme, and 100 mg of azobisisobutyronitrile in 7 g of tetrahydrofuran, and was coated on lithium which had been deposited to a thickness of 15 microns on a copper current collector. Cross-linking was performed in an oven at 80° C. A lithium half cell was prepared using the lithium on which a cross-linked hexadiol diacrylate layer with a thickness of 1 micron had been formed as a working electrode, and a lithium foil with a thickness of 100 microns as a counter electrode. A porous polyethylene separator with a thickness of 16 microns was placed between the working electrode and the counter electrode. A plastic pouch coated with aluminum was used, and dimethoxyethane/diglyme/dioxolane (volume ratio=4/4/2) in which 1M LiN(CF₃SO₂)₂ had been dissolved was injected as an electrolyte solution.

The resultant battery was charged and discharged for two hours with a current density of 1 mA/cm². The coulombic efficiency of the electrolyte solution was 73.1%, and the FOM was 3.72.

### Example 1

A solution was prepared by dissolving 0.2 g of branched poly(ethylene oxide) (DAISO) having a weight-average molecular weight of 1,000,000 and 0.8 g of hexanediol diacrylate in 7.6 g of tetrahydrofuran. Then, 20 mg of azobisisobutyronitrile and 16 mg of phenylene dimaleimide were added and the solution was stirred for 10 minutes.

The resultant homogenous solution was applied on lithium which had been deposited to a thickness of 15 microns on a copper current collector, and coated using a spin coater operated at 1,000 rpm for 60 seconds. The lithium on which the passivation layer precursor film had been coated was heated at 80° C. for 2 hours under an argon atmosphere, so that the hexanediol diacrylate cross-linking monomers in the precursor were cross-linked. As a result, a passivation layer with a thickness of 1.2 microns was formed on the lithium electrode surface.

A lithium half cell was prepared using the lithium on which the passivation layer had been coated as a working electrode, and a lithium foil with a thickness of 100 microns as a counter electrode. A porous polyethylene separator with a thickness of 16 microns was placed between the working electrode and the counter electrode. A plastic pouch coated with aluminum was used, and dimethoxyethane/diglyme/dioxolane (volume ratio=4/4/2) in which 1M LiN(CF₃SO₂)₂ had been dissolved was injected as an electrolyte solution.

The resultant battery was charged and discharged for two hours with a current density of 1 mA/cm². FIG. 7 shows the cell voltage change during charging and discharging. During the 16th charging, the cell voltage rose to 1.5 V. This means that lithium was depleted at the working electrode by the 16th cycle. The coulombic efficiency of the electrolyte solution was 90.0%, and the FOM was 10.1.

### Example 2

A solution was prepared by dissolving 0.4 g of polyvinyl chloride having a weight-average molecular weight of 100,000 and 0.6 g of hexanediol diacrylate in 15.2 g of tetrahydrofuran. Then, 20 mg of azobisisobutyronitrile were added and the solution was stirred for 10 minutes.

The resultant homogenous solution was applied on lithium which had been deposited to a thickness of 15 microns on a copper current collector, and coated using a spin coater operated at 1,000 rpm for 60 seconds. The lithium on which the passivation layer precursor film had been coated was heated at 80° C. for 2 hours under an argon atmosphere, so that the hexanediol diacrylate cross-linking monomers in the precursor were cross-linked. As a result, a passivation layer with a thickness of 1 micron was formed on the lithium electrode surface.

A lithium half cell was prepared using the lithium on which the passivation layer had been coated as a working electrode, and a lithium foil with a thickness of 100 microns as a counter electrode. A porous polyethylene separator with a thickness of 16 microns was placed between the working electrode and the counter electrode. A plastic pouch coated with aluminum was used, and dimethoxyethane/diglyme/dioxolane (volume ratio=4/4/2) in which 1M LiN(CF₃SO₂)₂ had been dissolved was injected as an electrolyte solution.

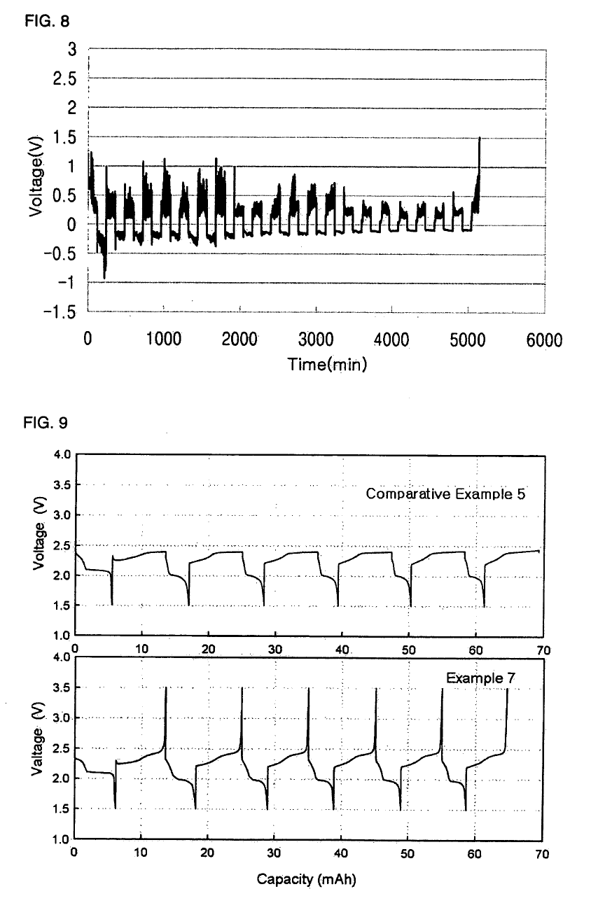

The resultant battery was charged and discharged for two hours with a current density of 1 mA/cm². FIG. 8 shows the cell voltage change during charging and discharging. During the 22nd charging, the cell voltage rose to 1.5 V. This means that lithium was depleted at the working electrode by the 22nd cycle. The coulombic efficiency of the electrolyte solution was 92.9%, and the FOM was 14.1.

The batteries of Examples 1 and 2 showed better lithium stabilization effects than those of Comparative Examples 2 and 3. Therefore, the passivation layer having a network structure of cross-linking polymer and linear polymer offers better lithium stabilization effects than a passivation layer comprising polyvinyl chloride or hexanediol diacrylate cross-linking polymer only.

### Example 3

A solution was prepared by dissolving 0.4 g of polyvinyl chloride having a weight-average molecular weight of 100,000, 0.6 g of hexanediol diacrylate, and 0.6 g of an inorganic single-ion conductor (inorganic particles) (OHARA) in 8.0 g of tetrahydrofuran. Then, 20 mg of azobisisobutyronitrile were added and the solution was stirred for 10 minutes.

The resultant homogenous solution was applied on lithium which had been deposited to a thickness of 15 microns on a copper current collector, and coated at 1,000 rpm for 60 seconds using a spin coater. The lithium on which the passivation layer precursor film had been coated was heated at 80° C. for 2 hours under an argon atmosphere, so that the hexanediol diacrylate cross-linking monomers in the precursor were cross-linked. As a result, a passivation layer with a thickness of 1.5 micron was formed on the lithium electrode surface.

A lithium half cell was prepared using the lithium on which the passivation layer had been coated as a working electrode, and a lithium foil with a thickness of 100 microns as a counter electrode. A porous polyethylene separator with a thickness of 16 microns was placed between the working electrode and the counter electrode. A plastic pouch coated with aluminum was used, and dimethoxyethane/diglyme/dioxolane (volume ratio=4/4/2) in which 1M LiN(CF₃SO₂)₂ had been dissolved was injected as an electrolyte solution.

The resultant battery was charged and discharged for two hours with a current density of 1 mA/cm². FIG. 8 shows cell voltage change during charging and discharging. During the 23rd charge, the cell voltage rose to 1.5 V. This means that lithium was depleted at the working electrode by the 23rd cycle.

The coulombic efficiency of the electrolyte solution was 90.0%, and the FOM was 14.9. The cell voltage during charging and discharging was 200 mV, which is only ⅕ of the passivation layer without an inorganic single-ion conductor. This means that addition of the inorganic single-ion conductor increased ion conductivity of the passivation layer, and thus the battery's overpotential decreased.

### Comparative Example 4

A positive electrode of a lithium sulfur battery having a capacity of 2 mAh/cm² was prepared using 75 wt % of inorganic sulfur (S₈), 15 wt % of a carbon conductor, and 10 wt % of a polyethylene oxide binder by the conventional method. A roll-type lithium sulfur battery was prepared using the positive electrode and a metallic lithium foil negative electrode with a thickness of 60 microns.

Dimethoxyethane/diglyme/dioxolane (volume ratio=4/4/2) in which 1M LiN(CF₃SO₂)₂ had been dissolved was used as an electrolyte solution. The theoretical capacity of the prepared battery was 25 mAh.

### Example 4

A roll-type lithium sulfur battery was prepared using the lithium metal electrode prepared in Example 2 and a sulfur positive electrode.

The sulfur positive electrode was prepared using 75 wt % of inorganic sulfur (S₈), 15 wt % of a carbon conductor, and 10 wt % of a polyethylene oxide binder by conventional methods. Dimethoxyethane/diglyme/dioxolane (volume ratio=4/4/2) in which 1M LiN(CF₃SO₂)₂ had been dissolved was used as an electrolyte solution. The theoretical capacity of the prepared battery was 25 mAh.

The lithium sulfur batteries prepared according to Comparative Example 4 and Example 4 were charged and discharged at a charging/discharging rate of 0.5 C/0.2 C. The discharging limit voltage was 1.5 V. Charging was performed at a 750 mAh cut-off, and the charging limit voltage was 3.5. Capacity was measured at each charging/discharging cycle. The results are shown in the following Table 1.

TABLE 1

| | 1st | 2nd | 5th | 10th | 50th | 100th |
|---|---|---|---|---|---|---|
| | cycle | cycle | cycle | cycle | cycle | cycle |
| Comparative | 17.4 | 12 | 12 | 11 | 9.7 | 5 |
| Example 4 | mAh | mAh | mAh | mAh | mAh | mAh |
| Example 4 | 17.3 | 15.1 | 15.0 | 14.8 | 14.6 | 13.2 |
| | mAh | mAh | mAh | mAh | mAh | mAh |

As seen in Table 1, the lithium sulfur battery of Example 4 showed better capacity characteristics than that of Comparative Example 4.

### Example 5

A solution was prepared by dissolving 0.2 g of branched poly(ethylene oxide) (DAISO) having a weight-average molecular weight of 1,000,000 and 0.8 g of hexanediol diacrylate in 7.6 g of tetrahydrofuran. Then, 20 mg of azobisisobutyronitrile and 16 mg of phenylene maleimide were added, and the solution was stirred for 10 minutes. The resultant homogenous solution was applied to lithium using a spin coater operating at 1,000 rpm for 60 seconds. The lithium had previously been deposited to a thickness of 15 microns on a copper current collector. As a result, a passivation layer precursor film having a thickness of 1.0 micron was formed on the lithium electrode surface. An electrode assembly was prepared by using lithium on which the passivation layer precursor film had been coated as a working electrode, and a lithium foil with a thickness of 100 microns as a counter electrode. A porous polyethylene separator with a thickness of 16 microns was placed between the working electrode and the counter electrode.

Cross-linking was performed at 80° C. for two hours while applying a pressure of 100 g/cm² to the electrode assembly under an argon atmosphere, so that the lithium electrode and the separator were bound together by the passivation layer. As a result, an electrode assembly having the structure shown in FIG. 5 was obtained.

The electrode assembly was vacuum-packed with an aluminum-coated plastic pouch to prepare a lithium half cell. Dimethoxyethane/diglyme/dioxolane (volume ratio=4/4/2) in which 1M LiN(CF₃SO₂)₂ had been dissolved was injected as an electrolyte solution.

The resultant battery was charged and discharged for two hours with a current density of 1 mA/cm². During the 35th charging, the cell voltage rose to 1.5 V. This means that lithium was depleted at the working electrode by the 35th cycle. The coulombic efficiency of the electrolyte solution was 95.6%, and the FOM was 22.6.

The higher coulombic efficiency and FOM are because of the uniform contact of the lithium negative electrode and the separator due to the passivation layer, which prevented locally concentrated oxidation and reduction of lithium.

### Example 6

A solution was prepared by dissolving 0.4 g of polyvinyl chloride having a weight-average molecular weight of 100,000 and 0.6 g of hexanediol diacrylate in 15.2 g of tetrahydrofuran. Then, 20 mg of benzophenone were added and the solution was stirred for 10 minutes. The resultant homogenous solution was applied to lithium using a spin coater operating at 1,000 rpm for 60 seconds. The lithium had previously been deposited to a thickness of 15 microns on a copper current collector. The lithium upon which the passivation layer precursor film had been formed was then exposed to UV light under an argon atmosphere for two minutes so that hexanediol diacrylate cross-linking monomers in the precursor were cross-linked. As a result, a passivation layer precursor film having a thickness of 1.0 micron was formed on the lithium electrode surface.

A lithium half cell was prepared using lithium on which the passivation layer had been coated as a working electrode, and a lithium foil with a thickness of 100 microns as a counter electrode. A porous polyethylene separator with a thickness of 16 microns was placed between the working electrode and the counter electrode. An aluminum-coated plastic pouch was used, and dimethoxyethane/diglyme/dioxolane (volume ratio=4/4/2) in which 1M LiN(CF₃SO₂)₂ had been dissolved was injected as an electrolyte solution.

The resultant battery was charged and discharged for two hours with a current density of 1 mA/cm². During the 21st charging, the cell voltage rose to 1.5 V. This means that lithium was depleted at the working electrode by the 21st cycle. The coulombic efficiency of the electrolyte solution was 92.7%, and the FOM was 13.6.

### Comparative Example 5

A sulfur positive electrode comprising 84 wt % of sulfur, 12 wt % of carbon, and 4 wt % of binder, and having a capacity of 2 mAh/cm², and a lithium negative electrode on which lithium had been deposited to a thickness 15 microns on a 10 micron-thick copper foil were used to prepare a battery. Dimethoxyethane/diglyme/dioxolane (volume ratio=4/4/2) in which 1M LiN(CF₃SO₂)₂ had been dissolved was used as an electrolyte solution.

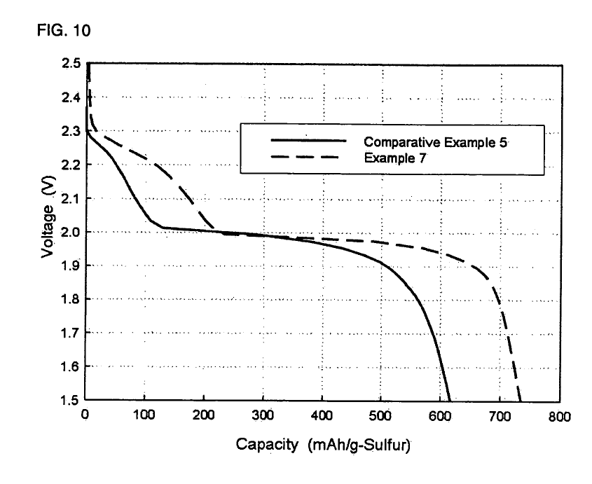

The theoretical capacity of the battery was 8 mAh, the charging-discharging rate was 0.2 C/0.2 C, and the discharging limit voltage was 1.5V. Charging was performed at a 10 mAh cut-off or under the charging limit voltage of 3.5. FIG. 9 shows the initial charging-discharging graph of the battery. FIG. 10 shows the capacity graph of the battery.

### Example 7

A lithium sulfur battery was prepared as in Comparative Example 5, except for coating a passivation layer precursor comprising PVC having a weight-average molecular weight of 200,000 and hexanediol diacrylate at a 5/5 ratio, by weight, on the lithium negative electrode, and cross-linking at 80° C. for two hours to form a passivation layer having a thickness of 1 micron. Initial charging-discharging characteristics and capacity were determined. FIG. 9 shows the initial charging-discharging graph of the battery. FIG. 10 shows the capacity graph of the battery.

As seen in FIG. 9, charging voltage of the lithium sulfur battery of Example 7 rises up to 3.5 V, but that of Comparative Example 5 remains at 2.4 V. This is because the passivation layer blocks reaction of polysulfide, an active material which has been eluted from the electrolyte solution, with lithium, so that self-discharging by the shuttle reaction is prevented. That is, the passivation layer of Example 7 blocks reaction of the positive electrode active material with the lithium negative electrode.

Also, as seen in FIG. 10, the lithium sulfur battery of Example 7 shows a higher discharging capacity at 2.3 V than that of Comparative Example 5. This is because the passivation layer blocks reaction of polysulfide with lithium. If there is no passivation layer, reaction of polysulfide with lithium is continued during charging.

Because the negative electrode for a lithium metal battery of the present invention has a passivation layer on the surface, reactivity of the negative electrode is reduced and the surface is stabilized, so that a lithium metal battery with superior life cycle characteristics can be obtained. Also, cross-linking can be easily performed after the linear polymer and the cross-linking polymer are prepared into a passivation layer precursor film. Furthermore, superior adhesivity of the passivation layer to the separator may contribute to improvement of uniformity of the negative electrode interface.

While the present invention has been described in detail with reference to the preferred embodiments, those skilled in the art will appreciate that various modifications and substitutions can be made thereto without departing from the spirit and scope of the present invention as set forth in the appended claims.

1. A negative electrode for a lithium metal battery comprising a negative active material layer of metallic lithium or a lithium alloy and a passivation layer on the negative active material layer, the passivation layer having a structure of a 3-dimensionally cross-linked polymer network matrix penetrated by linear polymers.

2. The negative electrode of claim 1, in which the weight-average molecular weight of the polymer chain of the cross-linked polymer network between each cross-linking point is from 50 to 100,000.

3. The negative electrode of claim 1, in which the cross-linked polymer is formed by cross-linking of cross-linking monomers selected from the group consisting of polyethylene oxide diacrylate, polyethylene oxide dimethacrylate, polypropylene oxide diacrylate, polypropylene oxide dimethacrylate, polymethylene oxide diacrylate, polymethylene oxide dimethacrylate, alkyldiol diacrylate, alkyldiol dimethacrylate, divinylbenzene, and mixtures thereof.

4. The negative electrode of claim 1, in which the weight-average molecular weight of the linear polymers is from 50,000 to 10,000,000.

5. The negative electrode of claim 1, wherein the linear polymers are selected from the group consisting of polyether, polycarbonate, polyamide, polyester, polyvinyl chloride, polyvinylidene fluoride, polyimide, polycarboxylate, polysulfonate, polyvinyl alcohol, polysulfone, polystyrene, polyethylene, polypropylene-based polymers, copolymers thereof, and mixtures thereof.

6. The negative electrode of claim 1, in which the weight ratio of the cross-linked polymer to the linear polymer is from 50/1 to 1/5.

7. The negative electrode of claim 6, in which the weight ratio of the cross-linked polymer to the linear polymer is from 10/1 to 1/1.

8. The negative electrode of claim 7, in which the weight ratio of the cross-linked polymer to the linear polymer is from 5/1 to 3/1.

9. The negative electrode of claim 1, in which the passivation layer further comprises inorganic particles in the polymer network.

10. The negative electrode of claim 9, wherein the inorganic particles are selected from the group consisting of SiO₂, Al₂O₃, TiO₂, BaTiO₂, Ba₂O₃, lithium oxysulfide, lithium nitride, lithium phosphorus oxynitride, lithium silicon disulfide, lithium boron disulfide, and mixtures thereof.

11. The negative electrode of claim 1, in which the negative electrode further comprises a lithium ion conductivity coating film between the negative active material layer and the passivation layer.

12. The negative electrode of claim 11, in which the lithium ion conductivity coating film is an inorganic coating film, an organic coating film, or a composite coating film thereof, wherein the inorganic coating film comprises a material selected from the group consisting of Cu, Al, Co, Fe, Ag, Zn, Mg, B, Sn, Pb, Cd, Si, In, Ga, lithium oxysulfide, lithium nitride, lithium phosphorus oxynitride, lithium silicon sulfide, lithium silicon disulfide, lithium boron sulfide, lithium boron disulfide, lithium silicate, lithium borate, lithium phosphate, lithium phosphoronitride, lithium aluminosulfide, and lithium phosphosulfide, and the organic passivation layer comprises a conductive monomer, oligomer, or polymer selected from the group consisting of poly(p-phenylene), polyacetylene, poly(p-phenylene vinylene), polyaniline, polypyrrole, polythiophene, poly(2,5-ethylene vinylene), acetylene, poly(perinaphthalene), polyacene, and poly(naphthalene-2,6-diyl).

13. A method of preparing a negative electrode for a lithium metal battery comprising:
preparing a homogeneous coating composition by mixing cross-linking monomers, a linear polymer, and a cross-linking initiator in a non-aqueous solvent;
coating the coating composition on a negative active material layer of metallic lithium or a lithium alloy, and drying the same to prepare a passivation layer precursor film; and
applying heat or UV light to the negative electrode on which the passivation layer precursor film has been formed.

14. The method of claim 13, in which the cross-linking monomers are selected from the group consisting of polyethylene oxide diacrylate, polyethylene oxide dimethacrylate, polypropylene oxide diacrylate, polypropylene oxide dimethacrylate, polymethylene oxide diacrylate, polymethylene oxide dimethacrylate, alkyldiol diacrylate, alkyldiol dimethacrylate, divinylbenzene, and mixtures thereof.

15. The method of claim 13, in which the linear polymer has a weight-average molecular weight from 50,000 to 10,000,000.

16. The method of claim 13, in which the linear polymer is selected from the group consisting of polyether, polycarbonate, polyamide, polyester, polyvinyl-chloride, polyvinylidene fluoride, polyimide, polycarboxylate, polysulfonate, polyvinyl alcohol, polysulfone, polystyrene, polyethylene, polypropylene-based polymers, copolymers thereof, and mixtures thereof.

17. The method of claim 13, in which the coating composition further comprises inorganic particles.

18. The method of claim 17, in which the inorganic particles are selected from the group consisting of SiO₂, Al₂O₃, TiO₂, BaTiO₂, Ba₂O₃, lithium oxysulfide, lithium nitride, lithium phosphorus oxynitride, lithium silicon disulfide, lithium boron disulfide, and mixtures thereof.

19. The method of claim 13, which further comprises forming a lithium ion conductivity coating film between the negative active material layer and the passivation layer.

20. The method of claim 19, in which the lithium ion conductivity coating film is an inorganic coating film, an organic coating film, or a composite coating film thereof, wherein the inorganic coating film comprises a material selected from the group consisting of Cu, Al, Co, Fe, Ag, Zn, Mg, B, Sn, Pb, Cd, Si, In, Ga, lithium oxysulfide, lithium nitride, lithium phosphorus oxynitride, lithium silicon sulfide, lithium silicon disulfide, lithium boron sulfide, lithium boron disulfide, lithium silicate, lithium borate, lithium phosphate, lithium phosphoronitride, lithium aluminosulfide, and lithium phosphosulfide, and the organic passivation layer comprises a conductive monomer, oligomer, or polymer selected from the group consisting of poly(p-phenylene), polyacetylene, poly(p-phenylene vinylene), polyaniline, polypyrrole, polythiophene, poly(2,5-ethylene vinylene), acetylene, poly(perinaphthalene), polyacene, and poly(naphthalene-2,6-diyl).

21. The method of claim 13, in which the cross-linking initiator is a peroxide or an azo compound.

22. The method of claim 21, wherein the cross-linking initiator is selected from the group consisting of benzoyl peroxide, lauryl peroxide, acetyl peroxide, dilauryl peroxide, di-tert-butyl peroxide, cumyl hydroperoxide, azobisisobutyronitrile, azobisisovaleronitrile, and mixtures thereof.

23. The method of claim 13, in which the coating composition further comprises a lithium salt.

24. A lithium metal battery comprising:
a negative electrode comprising a negative active material layer of metallic lithium or a lithium alloy and a passivation layer formed on the negative active material layer, the passivation layer having a structure of a 3-dimensionally cross-linked polymer network matrix penetrated by linear polymers;
a positive electrode comprising a positive electrode active material; and
an electrolyte solution.

25. The lithium metal battery of claim 24, in which the weight-average molecular weight of the polymer chain in the cross-linked polymer network between each cross-linking point is from 50 to 100,000.

26. The lithium metal battery of claim 24, in which the cross-linked polymer is prepared by cross-linking of cross-linking monomers selected from the group consisting of polyethylene oxide diacrylate, polyethylene oxide dimethacrylate, polypropylene oxide diacrylate, polypropylene oxide dimethacrylate, polymethylene oxide diacrylate, polymethylene oxide dimethacrylate, alkyldiol diacrylate, alkyldiol dimethacrylate, divinylbenzene, and mixtures thereof.

27. The lithium metal battery of claim 24, wherein the weight-average molecular weight of the linear polymer is from 50,000 to 10,000,000.

28. The lithium metal battery of claim 24, wherein the linear polymer is selected from the group consisting of polyether, polycarbonate, polyamide, polyester, polyvinyl chloride, polyvinylidene fluoride, polyimide, polycarboxylate, polysulfonate, polyvinyl alcohol, polysulfone, polystyrene, polyethylene, polypropylene-based polymers, copolymers thereof and mixtures thereof.

29. The lithium metal battery of claim 24, in which the weight ratio of the cross-linked polymer to the linear polymer is from 50/1 to 1/5.

30. The lithium metal battery of claim 29, in which the weight ratio of the cross-linked polymer to the linear polymer is from 10/1 to 1/1.

31. The lithium metal battery of claim 30, in which the weight ratio of the cross-linked polymer to the linear polymer is from 5/1 to 3/1.

32. The lithium metal battery of claim 24, wherein the passivation layer further comprises inorganic particles in the polymer network.

33. The lithium metal battery of claim 32, wherein the inorganic particles are selected from the group consisting of SiO₂, Al₂O₃, TiO₂, BaTiO₂, Ba₂O₃, lithium oxysulfide, lithium nitride, lithium phosphorus oxynitride, lithium silicon disulfide, lithium boron disulfide, and mixtures thereof.

34. The lithium metal battery of claim 24, wherein the negative electrode further comprises a lithium ion conductivity coating film between the negative active material layer and the passivation layer.

35. The lithium metal battery of claim 34, in which the lithium ion conductivity coating film is an inorganic coating film, an organic coating film, or a composite coating film thereof, wherein the inorganic coating film comprises a material selected from the group consisting of Cu, Al, Co, Fe, Ag, Zn, Mg, B, Sn, Pb, Cd, Si, In, Ga, lithium oxysulfide, lithium nitride, lithium phosphorus oxynitride, lithium silicon sulfide, lithium silicon disulfide, lithium boron sulfide, lithium boron disulfide, lithium silicate, lithium borate, lithium phosphate, lithium phosphoronitride, lithium aluminosulfide, and lithium phosphosulfide, and the organic passivation layer comprises a conductive monomer, oligomer, or polymer selected from the group consisting of poly(p-phenylene), polyacetylene, poly(p-phenylene vinylene), polyaniline, polypyrrole, polythiophene, poly(2,5-ethylene vinylene), acetylene, poly(perinaphthalene), polyacene, and poly(naphthalene-2,6-diyl).

36. The lithium metal battery of claim 24, which further comprises a separator between the negative electrode and the positive electrode, wherein the negative electrode and the passivation layer are bound to the separator.
